(19) United States
(12) Patent Application Publication
(10) Pub. No.: US 2025/0224588 A1
(43) Pub. Date: Jul. 10, 2025

(54) LENS APPARATUS AND IMAGE PICKUP APPARATUS

(71) Applicant: CANON KABUSHIKI KAISHA, Tokyo (JP)

(72) Inventors: YOSHIKAZU WATANABE, Chiba (JP); TORU ISHIMASA, Kanagawa (JP); TOSHIHIRO OGAWA, Tokyo (JP)

(21) Appl. No.: 18/972,140

(22) Filed: Dec. 6, 2024

(30) Foreign Application Priority Data
Jan. 10, 2024 (JP) 2024-001551

(51) Int. Cl. G02B 7/04; G02B 7/02; G02B 7/14; G03B 13/32; G03B 17/14

(52) U.S. Cl. CPC G02B 7/04; G02B 7/021; G02B 7/14; G03B 13/32; G03B 17/14

(57) ABSTRACT

A lens apparatus includes a cam barrel formed with a first cam groove and a second cam groove and configured to rotate about an optical axis, a first holder including a first cam follower and configured to move along the optical axis in accordance with rotation of the cam barrel, the first cam follower engaging with the first cam groove, a second holder including a second cam follower and configured to move along the optical axis in accordance with rotation of the cam barrel, the second cam follower engaging with the second cam groove, a first guide member configured to guide the first holder movably along the optical axis, and a first biasing member configured to urge the first holder in an optical axis direction. Width of the first cam groove is larger than width of the first cam follower, and the first biasing member is held by the first holder and the second holder.

### BACKGROUND

### Technical Field

The present disclosure relates to a lens apparatus and an image pickup apparatus.

### Description of Related Art

Japanese Patent Laid-Open No. 2018-97254 discloses a lens barrel (lens apparatus) including an adjusting mechanism configured to adjust the tilt of a lens.

However, with the lens apparatus disclosed in Japanese Patent Laid-Open No. 2018-97254, it is difficult to suppress relative inclination of a plurality of lenses at a predetermined zoom position while also suppressing relative inclination of a plurality of lenses at another zoom position.

Furthermore, for example, in a case where the posture of the lens apparatus changes as a user attempts to capture an image in the upward or downward direction, variation in the interval between a plurality of lenses potentially causes image degradation.

### SUMMARY

A lens apparatus according to one aspect of the present disclosure includes a cam barrel formed with a first cam groove and a second cam groove and configured to rotate about an optical axis, a first holder including a first cam follower and configured to move along the optical axis in accordance with rotation of the cam barrel, the first cam follower being configured to engage with the first cam groove, a second holder including a second cam follower and configured to move along the optical axis in accordance with rotation of the cam barrel, the second cam follower being configured to engage with the second cam groove, a first guide member configured to guide the first holder movably along the optical axis, and a first biasing member configured to urge the first holder in an optical axis direction. Width of the first cam groove is larger than width of the first cam follower, and the first biasing member is held by the first holder and the second holder.

Further features of various embodiments of the disclosure will become apparent from the following description of embodiments with reference to the attached drawings.

### BRIEF DESCRIPTION OF THE DRAWINGS

FIGS. 1A and 1B are external perspective views of an image pickup apparatus in the present embodiment.

FIG. 2 is a block diagram of the image pickup apparatus in the present embodiment.

FIG. 3 is a cross-sectional view of an interchangeable lens in the present embodiment (wide-angle end during imaging).

FIG. 4 is a cross-sectional view of the interchangeable lens in the present embodiment (telephoto end during imaging).

FIG. 5 is a cross-sectional view of the interchangeable lens in the present embodiment (retractable end during non-imaging).

FIG. 6 is a perspective view of a rear group unit in the present embodiment.

FIG. 7 is a disassembled perspective view of the rear group unit in the present embodiment.

FIGS. 8A and 8B are perspective views of a fourth zoom unit in the present embodiment.

FIGS. 9A to 9C are configuration diagrams of the rear group unit and a cam barrel in the present embodiment.

FIG. 10 is a bottom view of the rear group unit and the cam barrel in the present embodiment.

FIGS. 11A and 11B are main-part enlarged views of a first cam groove in the present embodiment.

FIG. 12 is a cross-sectional view of the fourth zoom unit in the present embodiment.

### DETAILED DESCRIPTION

An embodiment of the present disclosure will be described below in detail with reference to the accompanying drawings. The same reference sign in the drawings indicates identical or corresponding parts. In the present embodiment, an interchangeable lens will be described below as an example of an optical apparatus, but the present disclosure may be modified and changed for a lens integrated cameras or the like in various manners within the range of its scope.

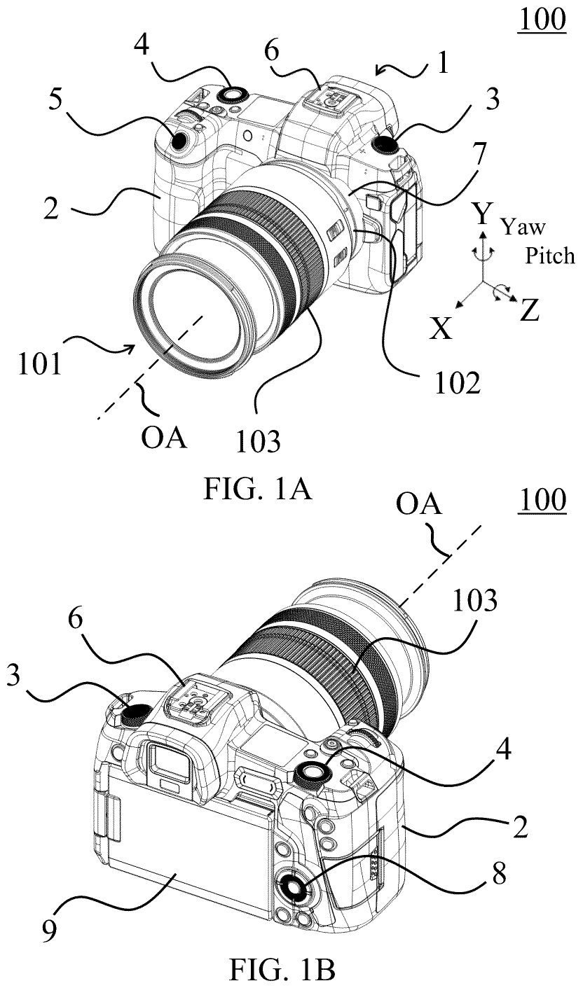

First, an image pickup apparatus (imaging system) 100 in the present embodiment will be described below with reference to FIGS. 1A and 1B. FIGS. 1A and 1B are external perspective views of the image pickup apparatus 100, FIG. 1A illustrating a perspective view when viewed from the front side (object side), and FIG. 1B illustrating a perspective view when viewed from the rear side (image plane side). In the present embodiment, as illustrated in FIG. 1A, an X-axis direction is defined as an optical axis direction in which an optical axis OA of an image pickup optical system housed in an interchangeable lens 101 extends (direction along the optical axis), a Z-axis direction (horizontal direction) and a Y-axis direction (vertical direction) are defined as directions orthogonal to the optical axis direction. Hereinafter, the Z-axis direction and the Y-axis direction are also collectively referred to as the Z/Y-axis directions. In addition, a pitch direction is defined as the rotational direction about the Z axis, and a yaw direction is defined as the rotational direction about the Y axis. The pitch direction and the yaw direction (hereinafter also collectively referred to as pitch/yaw directions) are rotational directions about the two axes of the Z and Y axes orthogonal to each other.

The image pickup apparatus 100 includes a camera body (digital camera or image pickup apparatus body) 1 and an interchangeable lens (lens apparatus or lens barrel) 101 detachably attached to the camera body 1. However, the present embodiment is not limited thereto but is also applicable to an image pickup apparatus in which a camera body and a lens apparatus are integrated.

A grip portion 2 for a user to grasp the camera body 1 with a hand is provided at a part of the camera body 1 on the left side when viewed from the front (right side when viewed from the rear). In addition, a power operation unit 3 is disposed at an upper surface part of the camera body 1. When the user switches on the power operation unit 3 while the camera body 1 is off, energization is started and the camera body 1 is turned on, and accordingly, a computer program such as origin detection processing for a focus unit is executed to achieve an imaging standby state. Then, when the user switches off the power operation unit 3 while the camera body 1 is on, the camera body 1 is turned off.

A mode dial 4, a release button 5, and an accessory shoe 6 are provided at the upper surface part of the camera body 1. Imaging modes can be switched as the user rotationally operates the mode dial 4. The imaging modes include a manual still-image imaging mode in which the user can optionally set imaging conditions such as the shutter speed and the aperture value, an automatic still-image imaging mode in which an appropriate exposure amount is automatically obtained, and a motion-image imaging mode for imaging a motion image. Imaging preparation operations such as autofocus and automatic exposure control can be instructed as the user performs a half-press operation on the release button 5, and imaging can be instructed as the user performs a full-press operation on the release button 5. An accessory (camera accessory) of an illumination or light emission device such as an external flash is detachably mounted on the accessory shoe 6.

The interchangeable lens 101 includes a lens mount 102 mechanically and electrically connectable to a camera mount 7 provided at the camera body 1. The lens mount 102 and the camera mount 7, which each have a circular ring shape, are formed of a conductive metallic material and detachably attached to each other through a non-illustrated bayonet connect. Combination of the interchangeable lens 101 and the camera body 1 is not restricted as long as a common mount shape is employed as a camera system.

An image pickup optical system configured to form an object image by imaging light from an object is housed in the interchangeable lens 101. A zoom operation ring (operation member) 103 that is rotatable with a center at the optical axis (about the optical axis) by a user operation is provided at the outer periphery of the interchangeable lens 101. As the zoom operation ring 103 is rotationally operated by the user, a zoom unit constituting the image pickup optical system moves to a predetermined use position corresponding to the angle of the zoom operation ring 103 in a range from a wide-angle end to a telephoto end. Accordingly, the user can perform imaging at a desired angle of view. Although described later in detail, in the present disclosure, a retractable end where imaging is further restricted is provided beyond rotational operation of the zoom operation ring 103 from the telephoto end to the wide-angle end. The retractable end is a position where the interchangeable lens 101 is most retracted.

As illustrated in FIG. 1B, a rear operation unit 8 and a display unit 9 are provided on the rear surface of the camera body 1. The rear operation unit 8 includes a plurality of buttons and dials allocated with various functions. When the camera body 1 is on and the still-image or motion-image imaging mode is set, the display unit 9 displays a live-view image of an object image picked up by an image sensor to be described later. The display unit 9 also displays imaging parameters indicating imaging conditions such as the shutter speed and the aperture value. While viewing the display, the user can operate the rear operation unit 8 to change set values of the imaging parameters. The rear operation unit 8 includes a playback button for instructing playback of recorded pickup images. As the user operates the playback button, pickup images are played back and displayed on the display unit 9. The display unit 9 may be configured as a touch panel with functions similar to those of the rear operation unit 8.

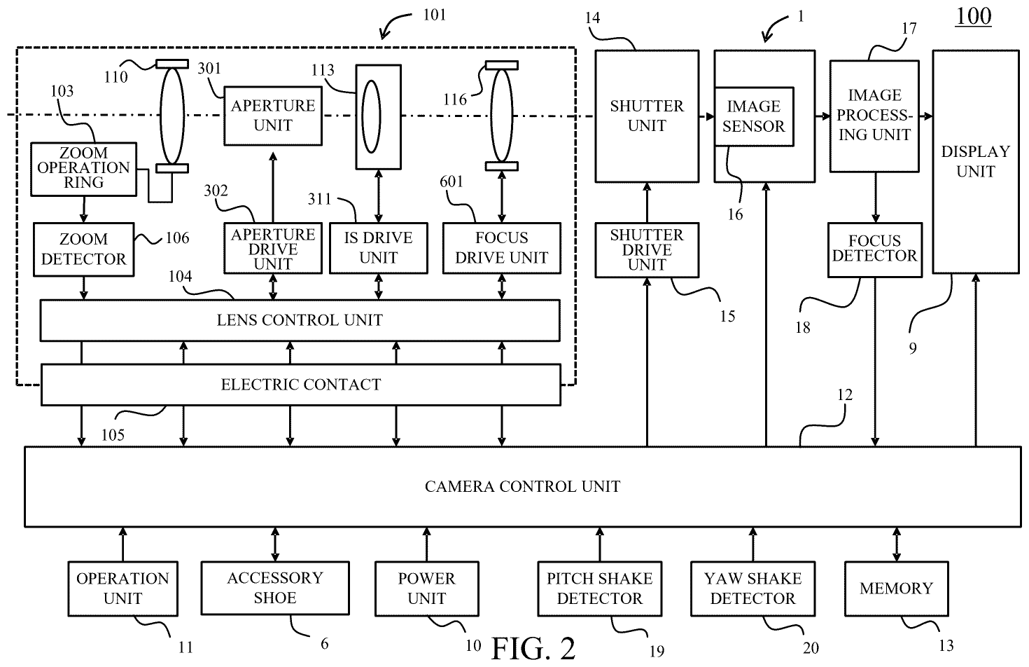

Electric and optical configurations of the image pickup apparatus 100 will be described below with reference to FIG. 2. FIG. 2 is a block diagram of the image pickup apparatus 100. The camera body 1 includes a power supply unit 10 configured to supply electric power to the camera body 1 and the interchangeable lens 101, the power operation unit 3, the mode dial 4, the release button 5, the rear operation unit 8, and an operation unit 11 including the touch panel functions of the display unit 9. Control of the camera body 1 and the interchangeable lens 101 as the entire system in the present embodiment is performed through cooperation of a camera control unit 12 provided at the camera body 1 and a lens control unit 104 provided at the interchangeable lens 101. Computers for controlling the camera body 1 and the interchangeable lens 101, respectively, are built in the camera control unit 12 and the lens control unit 104 and cooperatively operated to control the entire system of the camera body 1 and the interchangeable lens 101.

The camera control unit 12 reads and executes computer programs stored in a memory 13. Specifically, the camera control unit 12 communicates various kinds of control signals, data, and the like with the lens control unit 104 through a communication terminal of an electric contact 105 provided at the lens mount 102. The electric contact 105 includes a power terminal through which electric power from the power supply unit 10 is supplied to the interchangeable lens 101.

The image pickup optical system constituting the interchangeable lens 101 includes a zoom unit 110 coupled to the zoom operation ring 103 and configured to move in the optical axis direction to change the angle of view, and an aperture unit (opening aperture stop unit) 301 configured to perform light quantity adjustment operation. The image pickup optical system also includes a lens image stabilizing unit 113 including a shift lens as an image stabilization element and configured to move (shift) in the Z/Y-axis directions orthogonal to the optical axis to reduce image blur. The image pickup optical system further includes a focus unit 116 including a focus lens configured to move in the optical axis direction to perform focus adjustment. The interchangeable lens 101 includes an aperture drive unit 302 configured to drive the aperture unit 301, an image stabilization drive unit 311 configured to move the lens image stabilizing unit 113, and a focus drive unit 601 configured to move the focus unit 116.

The camera body 1 includes a shutter unit 14, a shutter drive unit 15, an image sensor 16, an image processing unit 17, and the camera control unit 12. The shutter unit 14 controls the amount of light to be imaged by the image pickup optical system in the interchangeable lens 101 and exposed to the image sensor 16. The image sensor 16 photoelectrically converts an object image formed through the image pickup optical system and outputs an image pickup signal. The image processing unit 17 performs various kinds of image processing on the image pickup signal and then generates an image signal. The display unit 9 displays the image signal (live-view image) output from the image processing unit 17, displays the imaging parameters, or plays back and displays pickup images recorded in the memory 13 or a non-illustrated recording medium.

The camera control unit 12 controls the focus drive unit 601 in accordance with an imaging preparation operation of the operation unit 11 (such as a half-press operation of the release button 5). For example, in a case where autofocus operation is instructed, a focus detector 18 determines the focus state of an object image picked up by the image sensor 16 based on an image signal generated by the image processing unit 17, generates a focal point signal, and transmits the focal point signal to the camera control unit 12. In addition, the focus drive unit 601 transmits information related to the current position of the focus unit 116 to the camera control unit 12. The camera control unit 12 compares the focus state of the object image and the current position of the focus unit 116, calculates a focus drive amount based on their difference amount, and transmits the focus drive amount to the lens control unit 104. Then, the lens control unit 104 moves the focus unit 116 to a target position in the optical axis direction through the focus drive unit 601, thereby correcting focus misalignment of the object image.

The focus drive unit 601 includes a focus motor that functions as an actuator, and a photo-interrupter configured to detect the origin position of the focus unit 116. Typically, a stepping motor as a kind of actuator is employed as the focus motor. For example, a DC motor including an encoder, an ultrasonic wave motor, or a servomotor may be employed as the focus motor. The photo-interrupter directly receives light emitted from a light emitting unit at a light receiving unit, but instead, a photo reflector configured to receive reflected light from a reflective surface, or a brush configured to contact a conductive pattern and electrically detect a signal may be used as a detector.

The camera control unit 12 controls drive of the aperture unit 301 and the shutter unit 14 through the aperture drive unit 302 and the shutter drive unit 15 in accordance with the set value of the aperture value or shutter speed received from the operation unit 11. For example, in a case where automatic exposure control operation is instructed, the camera control unit 12 receives a luminance signal generated by the image processing unit 17 and performs exposure metering calculation. Based on the result of the exposure metering calculation, the camera control unit 12 controls the aperture drive unit 302 in accordance with an imaging instruction operation of the operation unit 11 (such as a full-press operation of the release button 5). In addition, the camera control unit 12 controls drive of the shutter unit 14 through the shutter drive unit 15 and performs exposure processing by the image sensor 16.

The camera body 1 includes a pitch shake detector 19 and a yaw shake detector 20 as shake detection means capable of detecting image blur due to hand shake of the user or the like. The pitch shake detector 19 and the yaw shake detector 20 detect image blur in the pitch direction (rotational direction about the Z axis) and the yaw direction (rotational direction about the Y axis), respectively, by using an angular velocity sensor (vibration gyro) or an angle acceleration sensor, and output shake signals.

The camera control unit 12 calculates the shift position of the lens image stabilizing unit 113 in the Y-axis direction by using the shake signal from the pitch shake detector 19. Similarly, the camera control unit 12 calculates the shift position of the lens image stabilizing unit 113 in the Z-axis direction by using the shake signal from the yaw shake detector 20. Then, the camera control unit 12 moves the lens image stabilizing unit 113 to a target position in the Z/Y-axis directions through the image stabilization drive unit 311 in accordance with the calculated shift positions in the pitch/yaw directions, thereby reducing image blur during exposure or live-view image display.

The interchangeable lens 101 includes the zoom operation ring 103 for changing the angle of view of the image pickup optical system, and a zoom detector 106 configured to detect the angle of the zoom operation ring 103. The zoom detector 106 detects the angle of the zoom operation ring 103 being operated by the user as an absolute value and is configured by using, for example, a resistive linear potentiometer. Information related to the angle of view detected by the zoom detector 106 is transmitted to the lens control unit 104 and reflected onto various kinds of control by the camera control unit 12 described above. Part of the above-described various kinds of information is recorded in the memory 13, a non-illustrated recording medium, or the like together with pickup images.

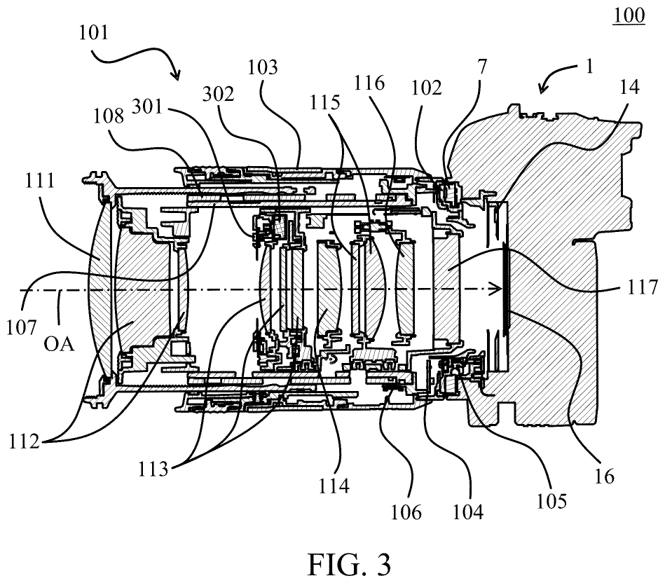

The positional relation among main components of the interchangeable lens 101 will be described below with reference to FIGS. 3 to 5. FIGS. 3 to 5 are cross-sectional views at an XY plane including the optical axis ONE ANOTHER. The central line illustrated in each drawing substantially matches the optical axis OA determined by the image pickup optical system, and thus is synonymous with the optical axis OA in the following description.

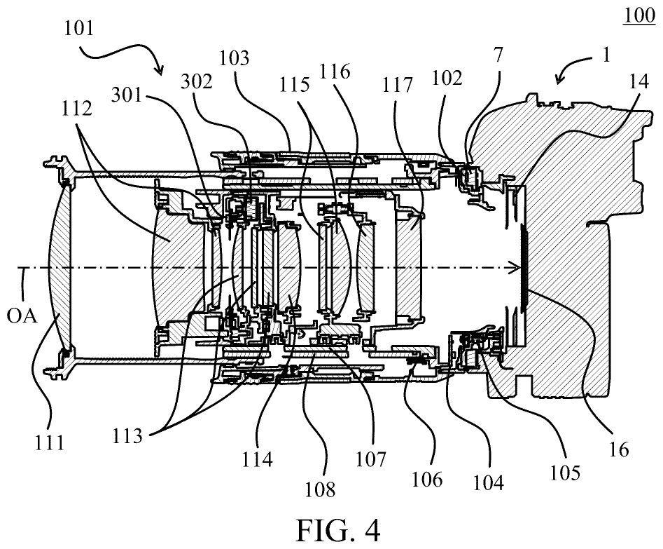

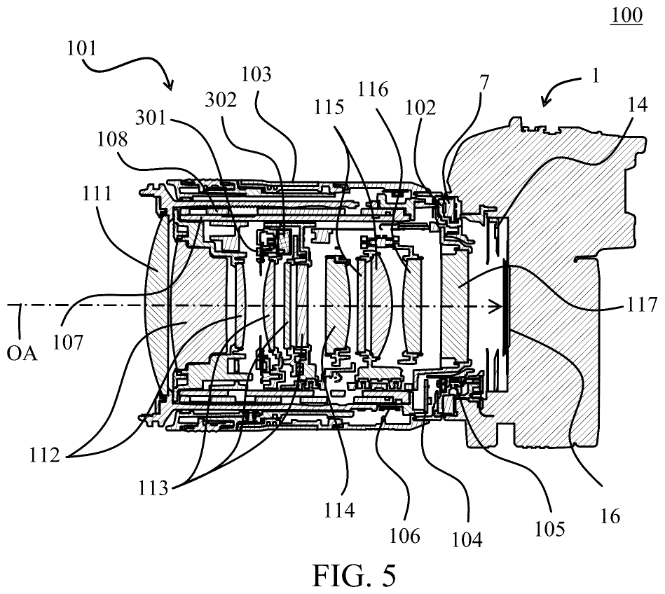

FIG. 3 illustrates the wide-angle end on the short focal point side in zooming, and FIG. 4 illustrates the telephoto end on the long focal point side in zooming. FIGS. 3 and 4 each corresponds to a state in which the image pickup optical system of the interchangeable lens 101 is located at an imaging possible position (state in which imaging is possible). FIG. 5 illustrates a state in which the image pickup optical system of the interchangeable lens 101 is housed (located at a retracted position) during non-imaging. FIG. 5 corresponds to the retractable end where the overall length is most reduced in the optical axis direction.

The retractable end in FIG. 5 is provided beyond the wide-angle end in FIG. 3. As the zoom operation ring 103 is rotationally operated in one direction, transition sequentially occurs from the retractable end in FIG. 5 to the wide-angle end in FIG. 3 and then from the wide-angle end in FIG. 3 to the telephoto end in FIG. 4. In the present embodiment, a state in which imaging is possible by the image pickup optical system is referred to as an imaging state, and a state in which the image pickup optical system is located at the retracted position is referred to as a retracted state. The state in which imaging is possible means a state in which the functions of the image pickup apparatus 100 including the camera body 1 and the interchangeable lens 101 can constantly and normally be operated. A state in which imaging is restricted means a state in which at least some of the functions of the image pickup apparatus 100 including the camera body 1 and the interchangeable lens 101 do not normally operate. For example, in the state in which the image pickup optical system is located at the retracted position, it may be possible that an imaging action (that, for example, presses a shutter to image an object) can be performed but a pickup image is entirely or partially blurred due to an phenomenon such as defocus of the image.

As illustrated in FIGS. 3 and 4, an optical system of a seven-unit configuration is employed as an example the image pickup optical system in the present embodiment. The zoom unit 110 moves to different predetermined use positions at the wide-angle end and the telephoto end, respectively, and images light from an object onto the image sensor 16. The zoom unit 110 is constituted by a first zoom unit 111, a second zoom unit 112, the aperture unit 301, a lens image stabilizing unit (third zoom unit) 113, a fourth zoom unit 114, a fifth zoom unit 115, a focus unit (sixth zoom unit) 116, and a seventh zoom unit 117. In the present embodiment, the configuration of the image pickup optical system is not limited but, for example, at least one of the lens image stabilizing unit 113 and the focus unit 116 may be configured to function as another zoom unit. Moreover, some lens units may be fixed instead of being movable.

A linear guide barrel 107 is a fixed member (guide barrel) fixed to the lens mount 102 through a fixed barrel 109 and disposed inside a cam barrel 108. The fixed barrel 109 holds the zoom operation ring 103 rotatably about the optical axis. Non-illustrated bayonet clicks are disposed at equally spaced positions on the outer circumferential surface of the linear guide barrel 107. In addition, a non-illustrated circumferential groove is provided on the inner circumferential surface of the cam barrel 108. The cam barrel 108 is coupled to the zoom operation ring 103. As the user rotationally operates the zoom operation ring 103, the cam barrel 108 is regulated from moving in the optical axis direction because of fitting of the bayonet clicks and the circumferential groove, and rotates with a center at the optical axis OA (about the optical axis OA).

The linear guide barrel 107 is formed with, at equally spaced positions, linear guide grooves that regulates movement of the zoom unit 110 in the rotational direction and guides its linear movement in the optical axis direction. Similarly, the cam barrel 108 is formed with, at equally spaced positions, cam grooves having loci with different angles, respectively, in the rotational direction, corresponding to the zoom unit 110. The zoom unit 110 is provided with a plurality of rollers, and each roller is fitted to the corresponding linear guide groove and cam groove. As the user rotationally operates the zoom operation ring 103, the cam barrel 108 rotates and moves the zoom unit 110 in the optical axis direction (forward-backward movement) while regulating its movement in the rotational direction with the rollers fitted to the linear guide grooves and the cam grooves.

The interchangeable lens 101 of the present embodiment includes a retraction mechanism. With the retraction mechanism, the zoom unit 110 can further be retracted toward the rear side (image plane side) during non-imaging. Accordingly, the overall length of the interchangeable lens 101 can be reduced, thereby improving portability of the interchangeable lens 101 and the camera body 1.

At the wide-angle end illustrated in FIG. 3, the interval between the second zoom unit 112 and the lens image stabilizing unit (third zoom unit) 113 is long. At the telephoto end illustrated in FIG. 4, the interval between the first zoom unit 111 and the second zoom unit 112 is long. The retraction mechanism reduces these intervals for movement to the retracted position where the zoom units are close to each other, thereby reducing the overall length in the optical axis direction. As illustrated in FIG. 5, the zoom unit 110 is moved to the retracted position where the lens units are close to each other at the retractable end during non-imaging. In this state, for example, as the user rotationally operates the zoom operation ring 103 to the wide-angle end, the zoom unit 110 extends toward the front side (object side) and moves to a predetermined use position, thereby reaching the state in which imaging is possible illustrated in FIG. 3.

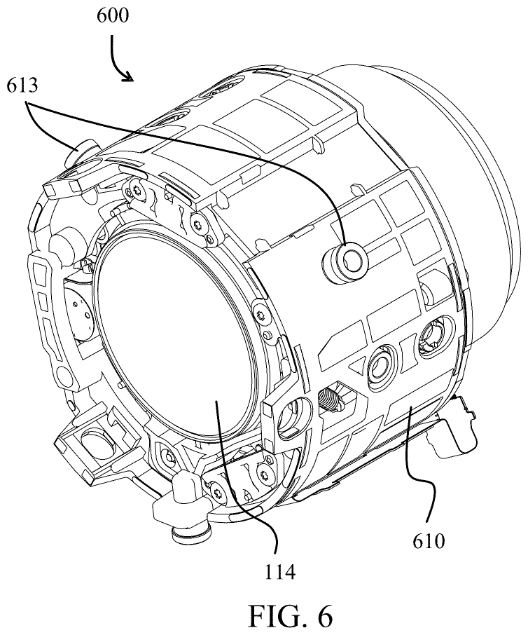

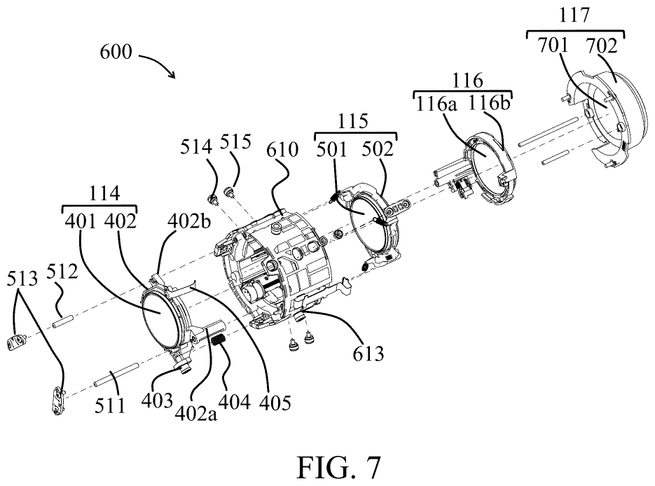

A rear group unit 600 of the interchangeable lens 101 will be described below with reference to FIGS. 6 and 7. FIG. 6 is a perspective view of the rear group unit 600 when viewed from the front side (object side). FIG. 7 is a disassembled perspective view of some members (components) constituting the rear group unit 600 illustrated in FIG. 6.

The rear group unit 600 includes a movement tube (second holder) 610. The fourth zoom unit 114 and the fifth zoom unit 115 are housed inside the movement tube 610. The fourth zoom unit 114 includes a fourth lens 401 and a fourth lens holding frame (first holder) 402 that holds the fourth lens 401. The fifth zoom unit 115 includes a fifth lens 501 and a fifth lens holding frame 502 that holds the fifth lens 501.

The fourth lens holding frame 402 includes a sleeve part 402a and a shake stopping part 402b. The sleeve part 402a is slidably fitted to a main guide (guide member or first guide member) 511 disposed substantially in parallel to the optical axis OA. The main guide 511 guides the fourth lens holding frame 402 movably along the optical axis OA. The shake stopping part 402b is slidably fitted to a sub guide (sub guide member or second guide member) 512 disposed substantially in parallel to the main guide 511. The sub guide 512 regulates movement of the fourth lens holding frame 402 in the rotational direction about the optical axis OA.

Respective ends of each of the main guide 511 and the sub guide 512 in the optical axis direction are supported by the movement tube 610 and a guide cap 513. The guide cap 513 is fixed to the movement tube 610. With such a configuration, the fourth zoom unit 114 is positioned in the Y-axis direction and the Z-axis direction by the main guide 511 and the sub guide 512. The fourth zoom unit 114 is smoothly movable in the optical axis direction (X-axis direction) between the movement tube 610 and the guide cap 513.

In the present embodiment, shaft members (the main guide 511 and the sub guide 512) are described as examples of a guide member and a sub guide member, but the present invention is not limited thereto. For example, plate members or wire members may be employed as a guide member and a sub guide member as long as guiding is possible with the members in the optical axis direction. In the present embodiment, the main guide 511 is inserted through the fourth lens holding frame 402 and held by the movement tube 610 and the guide cap 513, but the present invention is not limited thereto. The main guide 511 may alternatively be inserted through the movement tube 610 and held by the fourth lens holding frame 402.

Three first rollers 514 and three second rollers 515 are each provided at 120° equally spaced positions on the outer circumferential surface of the fifth lens holding frame 502. The first rollers 514 and the second rollers 515 are engaged with respective opening parts of the movement tube 610. The first rollers 514 and the second rollers 515 are eccentric, allowing eccentricity and thrust adjustment of the fifth zoom unit 115.

Three movement rollers (second cam followers) 613 are provided at equally spaced positions on the outer circumferential surface of the movement tube 610. As described above, each movement roller 613 is fitted to (engaged with) its corresponding linear guide groove and a second cam groove 108b to be described later. For example, during zooming from the wide-angle end to the telephoto end, the cam barrel 108 rotates and the movement tube 610 linearly moves in the optical axis direction integrally with a component such as the fourth zoom unit 114 in accordance with rotation of the cam barrel 108.

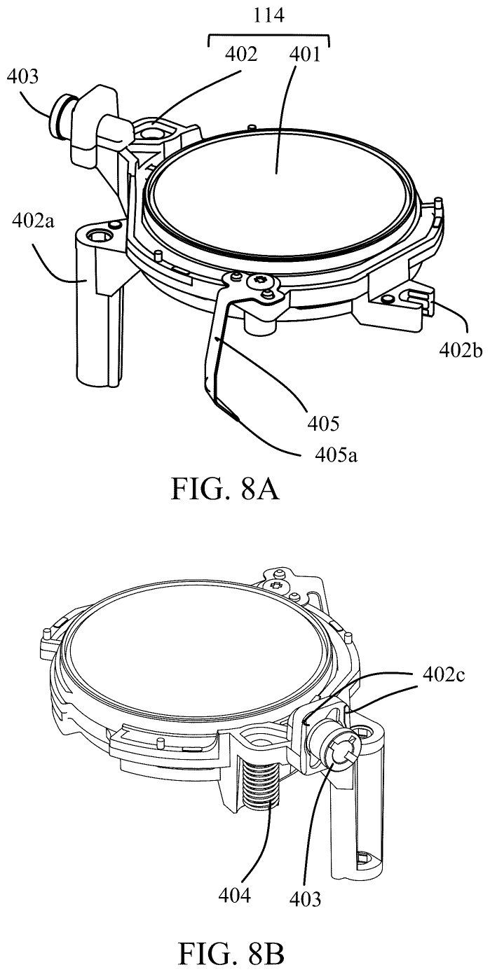

The fourth zoom unit 114 will be described below in detail with reference to FIGS. 8A and 8B. FIGS. 8A and 8B are perspective views of the fourth zoom unit 114 when viewed from the front side (object side). FIG. 8A illustrates a side surface where a second biasing member 405 is disposed. FIG. 8B illustrates a side surface where a first biasing member 404 is disposed.

Although described later in detail, the fourth lens holding frame 402 includes one eccentric roller (first cam follower) 403 that engages with a first cam groove 108a formed on the cam barrel 108. The eccentric roller 403 is capable of adjusting the fourth lens holding frame 402 in the optical axis direction. Relative inclination of the fourth lens holding frame 402 with respect to the movement tube 610 is prevented because of positioning by the main guide 511 and the sub guide 512 as described above. Accordingly, the fourth lens holding frame 402 is multiply fitted to the main guide 511 and the sub guide 512 when no minute gap (play) exists between the first cam groove 108a formed on the cam barrel 108 and the eccentric roller 403. As a result, the fourth lens holding frame 402 deforms or slidability with the main guide 511 decreases. Thus, in the present embodiment, the width of the first cam groove 108a is set to be larger than the width (outer diameter) of the eccentric roller 403 so that play is provided between the first cam groove 108a and the eccentric roller 403.

However, if such play exists, the eccentric roller 403 may unintendedly move in the range of play with the first cam groove 108a under influence of gravitational force or the like, for example, when the posture of the interchangeable lens 101 changes as the user attempts to pick up an image a posture position in the upward or downward direction. Thus, in the present embodiment, the first biasing member 404 is disposed between the fourth lens holding frame 402 and the movement tube 610. In other words, the first biasing member 404 is held by the fourth lens holding frame 402 and the movement tube 610. The first biasing member 404 urges the fourth lens holding frame 402 against the movement tube 610 in the optical axis direction. The first biasing member 404 is a spring member but not limited thereto and may be another elastic member such as a rubber member.

In the present embodiment, biasing force of the first biasing member 404 is set to be larger than the sum of the weight of the fourth lens holding frame 402 and the weight of the fourth lens 401. Accordingly, the fourth lens holding frame 402 is constantly play-minimized against gravitational force, and thus the interval (distance) between the fourth lens 401 and the fifth lens 501 in the optical axis direction can highly accurately be determined.

The second biasing member 405 is disposed between the fourth lens holding frame 402 and the movement tube 610. The second biasing member 405 urges the fourth lens holding frame 402 against the sub guide 512. More specifically, the second biasing member 405 generates a moment about the main guide 511 on the fourth lens holding frame 402 and urges the shake stopping part 402b against the sub guide 512. Accordingly, the fourth lens holding frame 402 is constantly play-minimized, and thus the position of the fourth lens 401 in the eccentricity direction can highly accurately be determined. An introduction part 405a with an oblique shape relative to the optical axis direction is provided at the leading end of the second biasing member 405. Linear insertion in the optical axis direction is possible as the second biasing member 405 enters following along insertion of the fourth zoom unit 114 (fourth lens holding frame 402) into the movement tube 610.

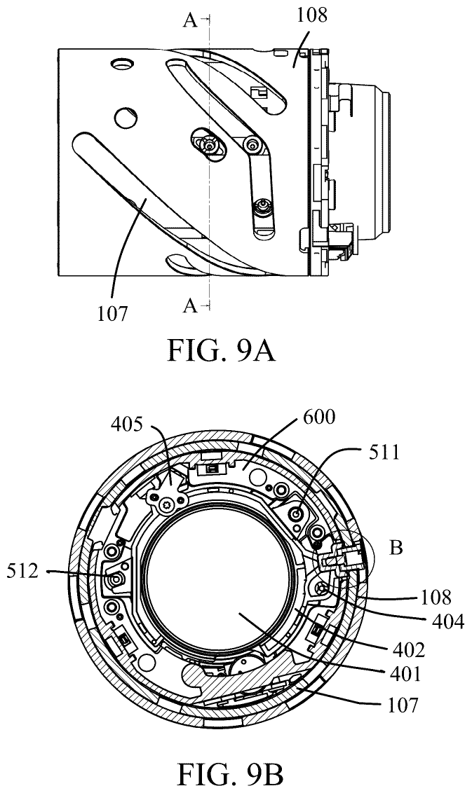

FIG. 9A is a side view of the rear group unit 600 of the present embodiment and components including the linear guide barrel 107 and the cam barrel 108. FIG. 9B is a cross-sectional view along line A-A in FIG. 9A. FIG. 9C is an enlarged view of area B in FIG. 9B. As illustrated in FIG. 9C, the fourth lens holding frame 402 is provided with an after-hitting part (contact part) 402c that contacts the linear guide barrel 107 when the interchangeable lens 101 is subjected to an external impact.

As illustrated in FIGS. 9B and 9C, when projected onto the image plane in a direction parallel to the optical axis OA, the distance between the first biasing member 404 serving as the point of force and the eccentric roller 403 serving as the fulcrum is shorter than the distance between the first biasing member 404 serving as the point of force and the main guide 511 serving as the point of action. In this manner, generation of unnecessary moments can be prevented by positioning the fulcrum closer to the point of force than the point of action.

Similarly, when projected onto the image plane in the direction parallel to the optical axis OA, the distance between the main guide 511 and the second biasing member 405 is longer than the distance between the main guide 511 and the eccentric roller 403. Accordingly, a moment about the main guide 511 can be generated with a relatively small load, and thus play can efficiently be minimized toward the sub guide 512.

When projected onto the image plane in the direction parallel to the optical axis OA, the distance between the main guide 511 and the sub guide 512 is longer than the distance between the main guide 511 and the second biasing member 405. In other words, the distance between the main guide 511 and the sub guide 512 among components constituting the fourth zoom unit 114 is longest (the guides are most separated), and thus stable movement is possible during zooming without losing the position accuracy of the fourth lens 401.

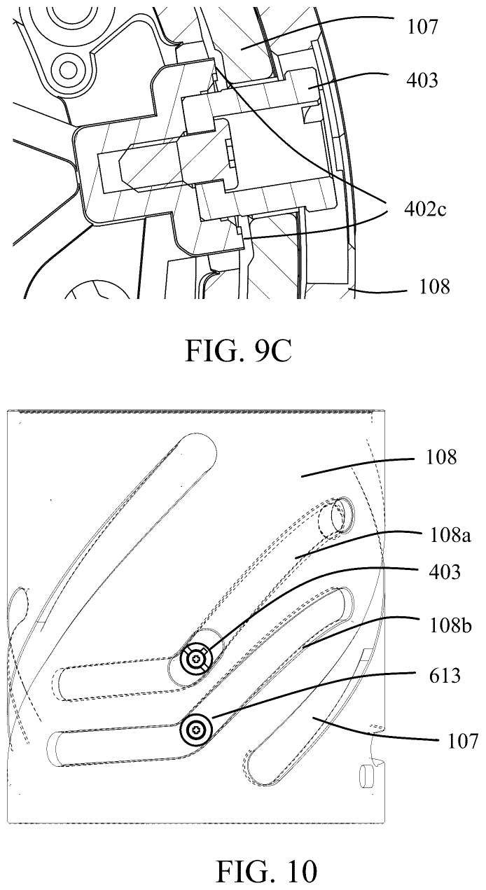

FIG. 10 is a bottom view illustrating the components in FIG. 9A from below in the Y-axis direction. The cam barrel 108 is formed with the first cam groove 108a and the second cam grooves 108b. The first cam groove 108a and each second cam groove 108b have loci different from each other. The first cam groove 108a is one groove formed corresponding to the eccentric roller 403. The second cam grooves 108b are three grooves formed at equally spaced positions corresponding to the movement rollers 613.

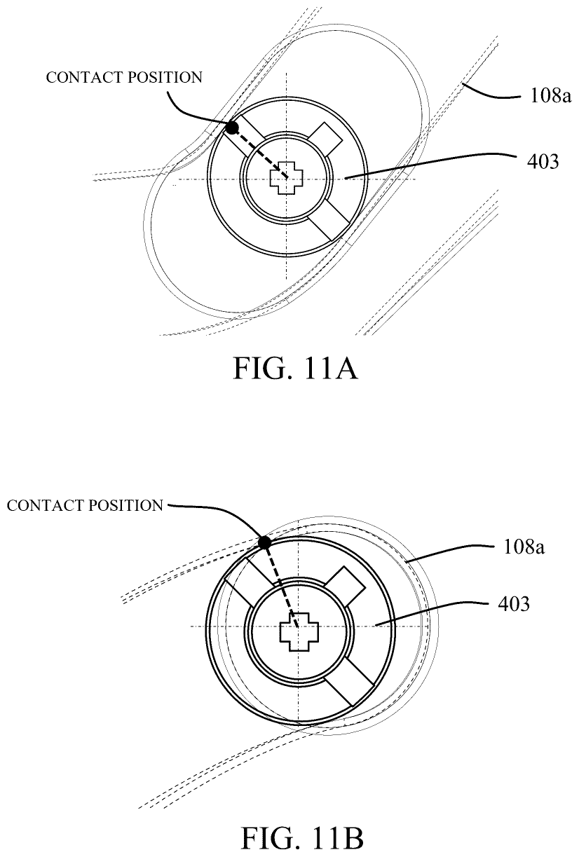

FIGS. 11A and 11B are main-part enlarged views of the first cam groove 108a illustrated in FIG. 10. FIG. 11A illustrates the first cam groove 108a at the wide-angle end, and FIG. 11B illustrates the first cam groove 108a at the telephoto end. The eccentric roller 403 is capable of adjusting the fourth lens holding frame 402 in the optical axis direction. The locus of the first cam groove 108a is a non-linear cam with different angles between the wide-angle end and the telephoto end. Accordingly, the contact position of the eccentric roller 403 with the first cam groove 108a changes in accordance with rotation of the cam barrel 108 as illustrated in FIGS. 11A and 11B. In this manner, the amount of adjustment of the fourth lens holding frame 402 in the optical axis direction changes between the wide-angle end and the telephoto end, but the change amount of the adjustment amount can be reduced because a washer 406 to be described later is provided.

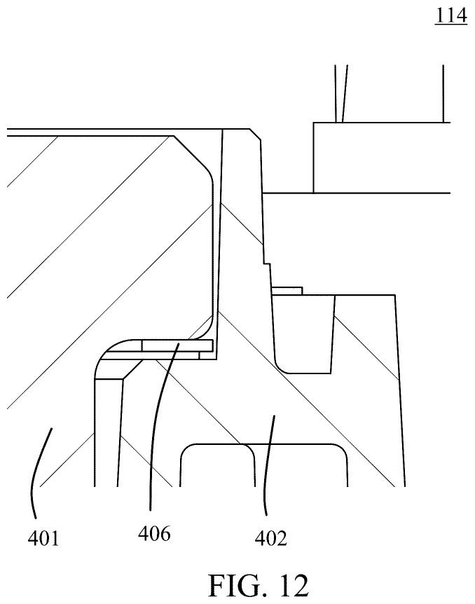

FIG. 12 is a cross-sectional view of the fourth zoom unit 114 in the present embodiment. The washer (adjusting member) 406 is a sheet member with a constant thickness and disposed between the fourth lens holding frame 402 and the fourth lens 401. The interval (distance) between the fourth lens 401 and the fifth lens 501 in the optical axis direction can be adjusted by changing the existence or thickness of the washer 406. The maximum adjustable amount with the eccentric roller 403 is smaller than the maximum adjustable amount with the washer 406.

In adjustment using the washer 406, the adjustment amount at each zoom position does not change, but continuous adjustment is impossible and the accuracy of adjustment is limited. Thus, by combining adjustment with the eccentric roller 403, which allows continuous adjustment, highly accurate adjustment is possible. Accordingly, adjustment error is reduced even when the locus of the first cam groove 108a is a non-linear cam.

According to the present embodiment, it is possible to provide a lens apparatus and an image pickup apparatus that are capable of reducing variation in the relative inclination and interval between the fourth lens 401 and the fifth lens 501 at each zoom position and reducing image quality degradation due to posture change.

While the disclosure has described example embodiments, it is to be understood that the disclosure is not limited to the example embodiments. The scope of the following claims is to be accorded the broadest interpretation so as to encompass all such modifications and equivalent structures and functions.

This application claims priority to Japanese Patent Application No. 2024-001551, which was filed on Jan. 10, 2024, and which is hereby incorporated by reference herein in its entirety.

What is claimed is:

1. A lens apparatus comprising:
a cam barrel formed with a first cam groove and a second cam groove and configured to rotate about an optical axis;
a first holder including a first cam follower and configured to move along the optical axis in accordance with rotation of the cam barrel, the first cam follower being configured to engage with the first cam groove;
a second holder including a second cam follower and configured to move along the optical axis in accordance with rotation of the cam barrel, the second cam follower being configured to engage with the second cam groove;
a first guide member configured to guide the first holder movably along the optical axis; and
a first biasing member configured to urge the first holder in an optical axis direction,
wherein width of the first cam groove is larger than width of the first cam follower, and
wherein the first biasing member is held by the first holder and the second holder.

2. The lens apparatus according to claim 1, wherein the first guide member is held by the first holder and inserted through the second holder.

3. The lens apparatus according to claim 1, wherein the first guide member is held by the second holder and inserted through the first holder.

4. The lens apparatus according to claim 1, wherein when projected onto an image plane in a direction parallel to the optical axis, distance between the first biasing member and the first cam follower is shorter than distance between the first biasing member and the first guide member.

5. The lens apparatus according to claim 1, further comprising a lens held by the first holder, wherein biasing force of the first biasing member is larger than a sum of weight of the first holder and weight of the lens.

6. The lens apparatus according to claim 1, wherein the first cam follower is an eccentric roller capable of adjusting the first holder in the optical axis direction.

7. The lens apparatus according to claim 6, wherein a contact position of the eccentric roller with the first cam groove changes in accordance with rotation of the cam barrel.

8. The lens apparatus according to claim 5, further comprising an adjusting member disposed between the first holder and the lens and configured to adjust distance between the first holder and the lens in the optical axis direction.

9. The lens apparatus according to claim 6, wherein a maximum adjustable amount with the eccentric roller is smaller than a maximum adjustable amount with the adjusting member.

10. The lens apparatus according to claim 1, further comprising:
a second guide member configured to regulate movement of the first holder in a rotational direction about the optical axis; and
a second biasing member configured to urge the first holder against the second guide member.

11. The lens apparatus according to claim 10, wherein the second biasing member includes an introduction part with an oblique shape relative to the optical axis direction.

12. The lens apparatus according to claim 10, wherein when projected onto an image plane in a direction parallel to the optical axis, distance between the first guide member and the second biasing member is longer than distance between the first guide member and the first cam follower.

13. The lens apparatus according to claim 10, wherein when projected onto an image plane in a direction parallel to the optical axis, distance between the first guide member and the second guide member is longer than distance between the first guide member and the second biasing member.

14. The lens apparatus according to claim 1, further comprising a guide barrel disposed inside the cam barrel, wherein the first holder includes a contact part that contacts the guide barrel in a case where the lens apparatus is subjected to an external impact.

15. An image pickup apparatus comprising:
a lens apparatus; and
an image sensor,
wherein the lens apparatus includes:
a cam barrel formed with a first cam groove and a second cam groove and configured to rotate about an optical axis,
a first holder including a first cam follower and configured to move along the optical axis in accordance with rotation of the cam barrel, the first cam follower being configured to engage with the first cam groove,
a second holder including a second cam follower and configured to move along the optical axis in accordance with rotation of the cam barrel, the second cam follower being configured to engage with the second cam groove,
a first guide member configured to guide the first holder movably along the optical axis, and
a first biasing member configured to urge the first holder in an optical axis direction,
wherein width of the first cam groove is larger than width of the first cam follower, and
wherein the first biasing member is held by the first holder and the second holder.
